(19) United States
(12) Patent Application Publication
(10) Pub. No.: US 2026/0261907 A1
(43) Pub. Date: Sep. 3, 2026

(54) L4S-Aware Network Coordination

(71) Applicant: T-Mobile Innovations LLC, Overland Park, KS (US)

(72) Inventor: Timur KOCHIEV, Irvine, CA (US)

(21) Appl. No.: 19/068,152

(22) Filed: Mar. 3, 2025

(51) Int. Cl. H04W 28/02; H04W 24/02; H04W 52/14

(52) U.S. Cl. CPC H04W 28/0284; H04W 24/02; H04W 52/146

(57) ABSTRACT

Systems, methods and devices are provided for L4S aware network coordination and congestion management. The method includes receiving, by a wireless network communicatively connected to an L4S capable access node and a non-L4S capable access node, a congestion signal from an L4S capable wireless device. In response to receiving the congestion signal from the L4S capable wireless device, the method adjusts, by the wireless network, network configurations for a non-L4S capable access node.

### TECHNICAL BACKGROUND

Low Latency Low Loss Scalable Throughput (L4S) is a technology intended to reduce queue delay problems, ensuring low latency to Internet Protocol flows with a high throughput performance. As of now, widespread implementation L4S is not common and only some equipment supports L4S. Thus, the devices that do not support L4S will likely have degraded user experience during congestion, such as packet losses, and add to the congestion of the overall network.

### OVERVIEW

Exemplary embodiments described herein include systems, methods, computer readable medium and processing nodes for L4S aware network coordination and congestion management. An exemplary method includes receiving, by a wireless network communicatively connected to an L4S capable access node and a non-L4S capable access node, a congestion signal from an L4S capable wireless device. The method further includes, in response to receiving the congestion signal from the L4S capable wireless device, adjusting, by the wireless network, network configurations for a non-L4S capable access node.

### BRIEF DESCRIPTION OF THE DRAWINGS

FIG. 1 illustrates an exemplary system for wireless communication in accordance with various aspects of the present disclosure;

FIG. 2 illustrates a block diagram illustrating an exemplary system for L4S aware network coordination;

FIG. 3 illustrates an exemplary process flow for network congestion management;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

There are a wide range of applications that rely on real-time communication, interactive experiences, or high-performance data transmission such as online and cloud gaming, video conferencing, AR/VR, live streaming, and others. All these applications can potentially benefit from the use of L4S technology.

L4S utilizes ECN (Explicit Congestion Notification) embedded within the IP header of an IP packet to signal queue congestion within a radio access network (RAN) to an application. This congestion information is handled by scalable congestion control algorithms at both the sender and receiver ends and communicated to the application server, prompting adjustments to the application's bitrate. As a result, it aligns with the capacity of the established communication link.

As of now, widespread support of L4S is not common and only some latest generation of access nodes (base stations) support L4S. It may take a significant time and effort to upgrade hardware on the base stations to fully support L4S across all carriers. L4S information received by L4S supported access nodes can be leveraged for network-wide coordination with non-supporting base stations to enhance overall congestion management, even if some access nodes do not support L4S currently.

The Network Data Analytics Function (NWDAF) in the core, such as the 5G core, can aggregate L4S-based congestion metrics (such as latency, ECN marking levels, and packet loss) from L4S capable access nodes and create a global view of network congestion patterns. This data can then be communicated to both L4S and non-L4S capable access nodes.

NWDAF can apply predictive analytics to anticipate congestion propagation and provide recommended actions to non-L4S access nodes, such as reducing uplink (UL) configurations, rebalancing traffic, or shifting non-L4S capable devices to lower-bitrate slices in congestion-prone areas.

Centralized self-organizing network (SON) functions coordinate congestion-related adjustments across both L4S and non-L4S capable access nodes. By receiving congestion alerts from L4S-enabled cells, SON can adjust cell boundaries, optimize handover thresholds, and direct traffic offload to underutilized non-L4S supported cells.

For example, SON facilitates cell boundary adjustments in non-L4S supported cells based on anticipated congestion in L4S cells, helping to balance network load and reduce congestion impacts on non-L4S supported wireless devices, especially in dense urban or high-traffic environments where maintaining stable performance is critical.

Intent-based radio access network (RAN) automation extends L4S-driven congestion responses across non-L4S supported cells. By interpreting high-level intents, such as “minimize latency impacts during high congestion,” the network can adapt slice configurations, prioritize essential traffic, and reduce UL layers where possible, even if non-L4S supported cells cannot process ECN signals directly. This allows non-L4S cells to benefit from congestion patterns observed in L4S-supporting cells, dynamically adjusting resources for continuity and quality of service (QoS) consistency.

An artificial intelligence/machine learning (AI/ML) model analyzes congestion patterns from L4S capable access nodes and generate predictions or configurations that apply to non-L4S supported cells. For example, historical L4S congestion patterns are used to forecast expected loads across nearby non-L4S supported cells.

Historical congestion data from L4S capable devices, including metrics like packet loss, delay, and throughput, can be aggregated along with network conditions (e.g., time of day, traffic loads). Key features might include frequency and duration of congestion events, traffic volume during peak hours, latency or packet loss trends by location or slice, and the like.

Accordingly, such ML models are used to suggest configurations for non-L4S capable access nodes, such as prioritizing low-bitrate slices or adjusting power control settings in UL. These adjustments are made dynamically via the backhaul to distribute load and mitigate congestion impact.

Policy-based control in the core uses L4S congestion data to optimize resource allocation across L4S and non-L4S supported cells. The core adjusts resources for non-L4S access nodes by lowering priority on non-essential traffic during congestion spikes or adjusting UL and download (DL) resource allocation to optimize for stability.

Policies prioritize handovers of non-L4S capable devices to non-L4S capable cells when L4S-enabled access nodes detect congestion, allowing the core to respond effectively even if non-L4S capable cells lack direct L4S functionality. By offloading non-L4S capable wireless devices to neighboring non-L4S capable cells, resources on the L4S capable cells are freed, allowing L4S-capable wireless devices to benefit more from the reduced congestion and efficiently manage their bitrate in response to ECN signals.

There are also access nodes that do not support L4S that would benefit from receiving congestion information from nearby L4S supported wireless devices. A cooperative network environment is provided where L4S supported wireless devices share network status and congestion information to improve user experience and network performance.

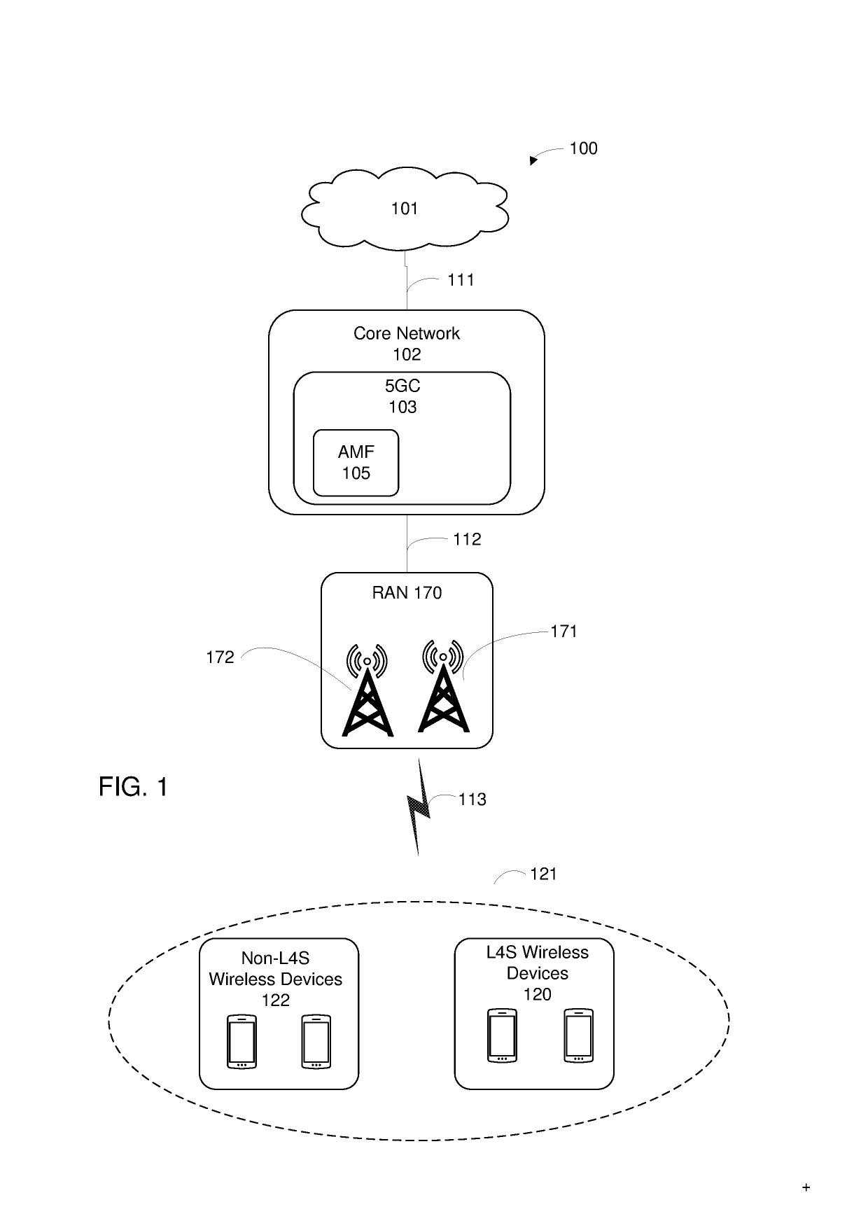

These and other examples will be described in greater detail below in relation to FIGS. 1-5.

FIG. 1 depicts an exemplary system 100 for network congestion management. System 100 includes a communication network 101, a core network 102, a radio access network (RAN) 170 and L4S capable wireless devices 120 and non-L4S capable wireless devices 122.

Core network 102 is connected to communication network 101 over communication link 111. Core network 102 includes a 5G core (5GC) 103. 5GC 103 as used herein are core network components used for managing data for 5G networks. In embodiments, 5GC 103 may include an evolved packet core (EPC), used for managing data for LTE, 4G and /or other networks. In instances, the core network 102 may have other types of core architecture (e.g., 6G core architecture) that at least perform some similar functions as and/or share at least some components with the 5GC 103 with respect to congestion management and network slicing for wireless devices.

It should be noted that core network 102 may include other components used for managing data for networks not described herein, such as a satellite core network.

In embodiments, 5GC 103 includes an access and mobility function (AMF) 105. AMF 105 receives connection and session related information from the L4S capable wireless devices 120 and non-L4S capable wireless devices 122 and is responsible for handling connection and mobility management tasks on a 5G network. In an embodiment, AMF 105 may be used for determining connection configuration for L4S capable wireless devices 120 and non-L4S capable wireless devices 122. For example, AMF 105 may communicate with a network slice selection function (NSSF) to determine a slice configuration based on changes in the quality of service (QoS) policies. In instances, AMF 105 may be used for assigning a network slice for non-L4S capable wireless devices 122.

The RAN 170 includes L4S capable access nodes 171 and non-L4S capable access nodes 172. In embodiments, access nodes 171 and non-L4S capable access nodes 172 include an evolved Node B (eNodeB) and a next generation Node B (gNodeB). As used herein, an eNode B is a base station in LTE/4G networks used for connecting a user device to core network 102. A gNodeB, as used herein, is a base station in 5G networks and/or other networks used for connecting a user device to core network 102. The gNodeB may include, for example, centralized units (CUs) and distributed units (DUs). In embodiments, the L4S capable access nodes 171 are equipped with L4S-aware scheduling and dual-queue active queue management (DualQ AQM). For example, L4S capable access nodes 171 may be configured to mark packets when congestion is detected in the network, such as through explicit congestion notification (ECN) marks.

RAN 170 is connected to core network 102 over communication link 112. RAN 170 may include other devices and additional nodes not described herein. For example, RAN 170 may include devices used for forwarding media files over IP from wireless devices 120 to core network 102.

System 100 also includes wireless devices 120. In embodiments, system 100 may include two or more wireless devices. Wireless devices 120 and 122 are configured to operate in one or more coverage areas 121. Wireless devices 120 and 122 may include an end-user wireless device. Wireless devices 120 and 122 may include any device configured to send and receive data. In embodiments, wireless device 120 communicates with RAN 170 over communication link 113. Examples of communication link 113 may include 5G network, 4G LTE, and the like.

In embodiments, wireless devices 120 include at least one L4S capable wireless device and wireless devices 122 include at least one non-L4S capable wireless device. L4S capable wireless devices 120 includes devices configured to support L4S traffic handling. In instances, L4S capable wireless devices 120 are configured to transmit congestion signals to 5GC 102.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The UPF may detect congestion of a network, such as form a L4S capable wireless device 120. In instances, the UPF may apply dual queue active queue management (DualQ AQM) based on the congestion detection. The control plane functions may include, for example, a network slice selection function (NSSF), a network exposure function (NEF), a network repository function (NRF), a policy control function (PCF), a unified data management (UDM) function, an application function (AF), an AMF, such as AMF 105, an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF 105, SMF 107, and NEF. The UDM may function as a stateful message store, holding information in local memory. The NSSF can be used by AMF 105 to assist with the selection of network slice instances that will serve a particular device. Further, the NEF provides a mechanism for securely exposing services and features of the core network.

In instances, the UDM may include a mapping of DNNs to network slice selection assistance information (nSSAI) associated with a wireless device 120. nSSAI includes a set of single nSSAI(S-nSSAI). Each S-nSSAI may include a slice/service type and a slice differentiator (SD). For example, AMF 105 may query UDM for S-nSSAIs associated with a DNN. In an example, AMF 105 may use NSSF for selecting a S-nSSAI based on additional requirements, such as regional availability. In some embodiments, UDM may detect a subscription expiration for a slice, such a validity period based slice, and notify AMF 105 of the expiration. Once notified, AMF 105 updates nSSAI by removing expired S-nSSAIs.

Although one core network 102 is shown, multiple core networks 102 may be utilized. Alternatively, the single core network 102 may include a distributed, cloud-native, converged core gateway. Thus, the converged core gateway could connect an EPC to 5GC 103 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as L4S capable access nodes 171 and non-L4S capable access nodes 172. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an eNodeB and others may communicate with a gNodeB.

In additional embodiments, access nodes 171 and 172 may comprise two co-located cells, or antenna/transceiver combinations that are mounted on the same structure. Alternatively, access nodes 171 and 172 may comprise a short range, low power, small-cell access node such as a microcell access node, a picocell access node, a femtocell access node, and/or a home eNodeB device. As will be further described below, functionality for network node switching may be included within the access nodes 171 and 172.Access nodes 171 and 172 can be configured to deploy one or more different carriers, utilizing one or more RATs. For example, a gNodeB may support NR. It would be evident to one of ordinary skill in the art, in light of this disclosure, the many other combinations of access nodes and carriers that could be deployed.

The access nodes 171 and 172 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The L4S capable wireless devices 120 and non-L4S capable wireless devices 122 may include any wireless device included in a wireless network. For example, the term “wireless device” may include a relay node, which may communicate with an access node. The term “wireless device” may also include an end-user wireless device, which may communicate with access nodes 171 and 172 through the relay node. The term “wireless device” may further include an L4S capable wireless device that communicates with the access node 171 directly without being relayed by a relay node or a non-L4S capable wireless device that communicates with access node 172. In embodiments, L4S capable wireless devices may be able to communicate with access nodes 171 or 172 regardless of L4S capability and non-L4S capable wireless devices may be able to communicate with access nodes 171 or 172 again regardless of non-L4S capability.

Wireless devices 120 and 122 may be any device, system, combination of devices, or other such communication platform capable of communicating wirelessly with access nodes 171 and 172 using one or more frequency bands and wireless carriers deployed therefrom. Each of wireless devices 120 and 122, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 and 122 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120 and 122. System 100 may include additional base stations, controller nodes, telephony switches, internet routers, network gateways, computer systems, communication links, other types of communication equipment, and combinations thereof.

Other network elements may be present in system 100 to facilitate communication but are omitted for clarity, such as base stations, base station controllers, mobile switching centers, and dispatch application processors. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network congestion management may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

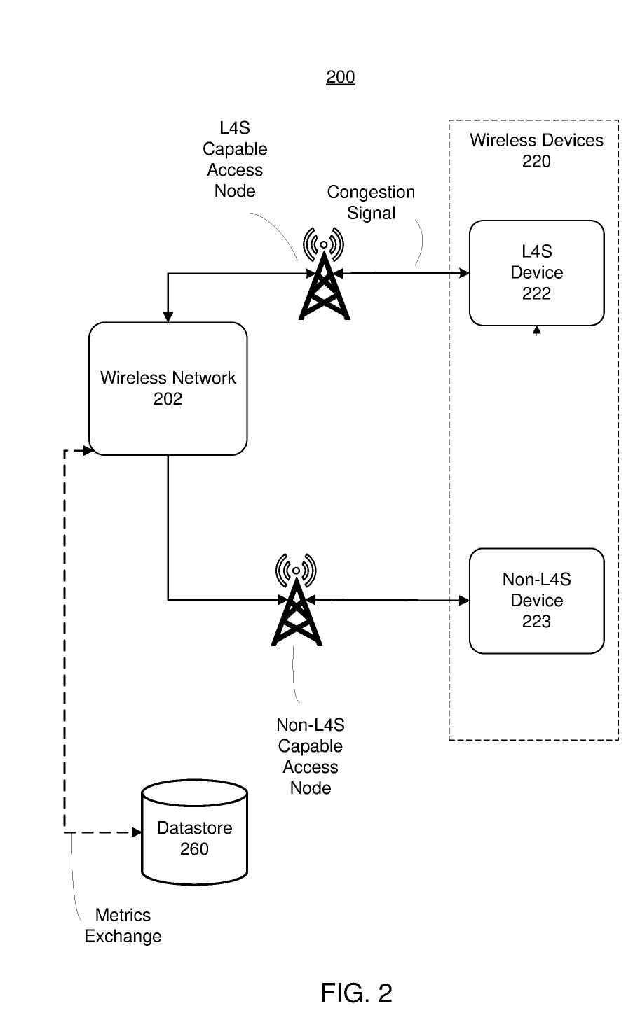

Now referring to FIG. 2, an exemplary system 200 for network congestion management is presented. System 200 includes wireless network 202. Wireless network 202 may include a RAN, core network and/or a communication network, which may be the same as, respectively, RAN 170, core network 102 and communication network 101. Wireless network 202 includes services and components used by a wireless network for L4S Aware network coordination. In an example, wireless network 202 is configured to utilize scalable congestion control algorithms, such as TCP Prague.

System 200 includes wireless devices 220. Wireless device 220 may be the same as wireless device 120. Wireless devices 220 include L4S capable device 222. In embodiments, wireless devices 220 may include a plurality of L4S devices 222. L4S device 222 may include any L4S capable device. For example, L4S device 222 may be any device capable of transmitting ECN-capable packets and receiving ECN feedback. In instances, L4S device 222 may use dual queue active management (DualQ AQM) for handling L4S and non-L4S traffic. In embodiments, L4S capable device 222 is configured to transmit congestion signals to wireless network 202. For example, a congestion signal may include an ECN signal, such as ECN-capable packets. It should be noted that wireless network 202 is described as receiving the congestion signal from a single L4S capable device 222 for ease of description, and as such, the congestion signal may include signals received from a plurality of L4S capable devices 222.

In embodiments, wireless network 202 includes non-L4S capable device 223. Non-L4S capable device 223 may include any device not capable of supporting L4S. In instances, wireless network 202 may include a plurality of non-L4S capable devices 223. In embodiments, non-L4S capable device 223 is connected to wireless network through a default connection. In some embodiments, the default connection may include a connection using a network slice.

Wireless network 202, based on detecting a congestion signal from L4S capable device 222, makes adjustments to network configurations including non-L4S capable access node and devices. The adjustments may include prioritizing low-bitrate slices for non-L4S capable access node(s); adjusting power control settings for UL for non-L4S capable access node(s); adapting slice configurations, such as slice type, slice throughput, radio spectrum, and isolation level, for the non-L4S capable access node(s); prioritizing essential (e.g., first responder, disaster relief, etc.) non-L4S traffic; reducing UL layers for non-L4S capable access node(s); assigning non-L4S capable wireless device(s) to non-L4S capable access node(s); moving (handover) the non-L4S capable wireless device(s) from the L4S capable access node(s) to non-L4S capable access node(s); adjusting UL and download (DL) resource allocation to optimize for stability for example, by using one or more KPIs for an access node, such as call set up success rate, dropped call rate, site data throughput, of the non-L4S capable access node(s); and adjusting cell boundaries of L4S and non-L4S capable access node(s). Furthermore, the adjustments may be any combination of the adjustments listed above.

In embodiments, wireless network 202 may exchange congestion metrics with a datastore 260. Datastore 260 may include any data storing medium, such as a database. In instances, data related to detected congestion signals may be stored in datastore 260 to be used as training data for machine learning processes. For example, data related to marked packets (i.e. congestion signal) may be correlated to timestamps for the signals, latency, ECN marking levels, and packet loss from L4S capable access nodes and L4S capable wireless devices. In embodiments, this training data may be used for training machine learning models, which may be used for predicting congestion in the network prior to or after detection of L4S congestion signals. For example, if network congestion is predicted adjustments or combinations of adjustments described above may be made to non-L4S capable access nodes. In an example, training data may include data related to frequency and duration of congestion events, such as congestion signals correlated to the length of time of detection of the signals. Training data may include network traffic volume during detection of signals. In an example, training data may also include packet loss for non-L4S device 223.

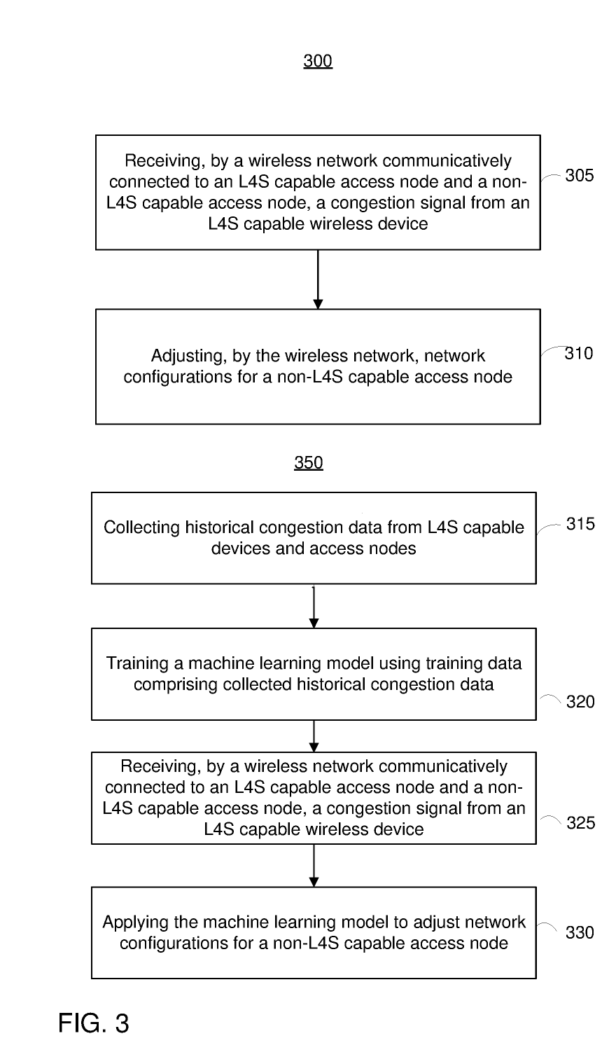

With reference to FIG. 3, a flow diagram of method 300 for network congestion management is presented. Method 300 includes, at step 305, receiving, by a wireless network communicatively connected to an L4S capable access node and a non-L4S capable access node, a congestion signal from an L4S capable wireless device. In embodiments, the congestion signal may include an ECN. The L4S capable access node and non-L4S capable access node may include, respectively, L4S capable access node 171 and non-L4S capable access node 172 described in reference to FIG. 1.

At step 310, method 300 includes adjusting, by the wireless network, network configurations for a non-L4S capable access node based on the congestion signal. The adjustment to network configurations for a non-L4S capable access node may include any combination of the following: prioritizing low-bitrate slices for non-L4S capable access node(s); adjusting power control settings for UL for non-L4S capable access node(s); adapting slice configurations for the non-L4S capable access node(s); prioritizing essential non-L4S traffic; reducing UL layers for non-L4S capable access node(s); assigning non-L4S capable wireless device(s) to non-L4S capable access node(s); moving (handover) the non-L4S capable wireless device(s) from the L4S capable access node(s) to non-L4S capable access node(s); adjusting UL and download (DL) resource allocation to optimize for stability of the non-L4S capable access node(s); and adjusting cell boundaries of L4S and non-L4S capable access node(s).

With reference to FIG. 3, a flow diagram of method 350 for network congestion management using machine learning is presented. Method 350 includes, at step 315, collecting historical congestion data from L4S capable devices and access nodes. The historical congestion data may be collected from L4S devices and access nodes throughout the network. The historical congestion data may include any combination of data related to ECN marked packets (i.e. congestion signal) correlated to timestamps for the signals, latency, ECN marking levels, and packet loss, frequency, duration of congestion events and time length congestion signals from L4S capable access nodes and L4S capable wireless devices.

At step 320, a machine learning model is trained using training data comprising collected historical congestion data. In an example, training data may include data related to frequency and duration of congestion events, such as congestion signals correlated to the length of time of detection of the signals. Training data may include network traffic volume during detection of signals. In an example, training data may also include packet loss for non-L4S device 223.

At step 325, the method includes receiving, by a wireless network communicatively connected to an L4S capable access node and a non-L4S capable access node, a congestion signal from an L4S capable wireless device. In embodiments, the congestion signal may include an ECN. The L4S capable access node and non-L4S capable access node may include, respectively, L4S capable access node 171 and non-L4S capable access node 172 described in reference to FIG. 1.

At step 330, the method includes inputting the congestion signal received in step 325 into the model trained in step 320 to adjust by the wireless network, network configurations for a non-L4S capable access node. The adjustment to network configurations for a non-L4S capable access node may include any combination of the following: prioritizing low-bitrate slices for non-L4S capable access node(s); adjusting power control settings for UL for non-L4S capable access node(s); adapting slice configurations for the non-L4S capable access node(s); prioritizing essential non-L4S traffic; reducing UL layers for non-L4S capable access node(s); assigning non-L4S capable wireless device(s) to non-L4S capable access node(s); moving (handover) the non-L4S capable wireless device(s) from the L4S capable access node(s) to non-L4S capable access node(s); adjusting UL and download (DL) resource allocation to optimize for stability of the non-L4S capable access node(s); and adjusting cell boundaries of L4S and non-L4S capable access node(s)

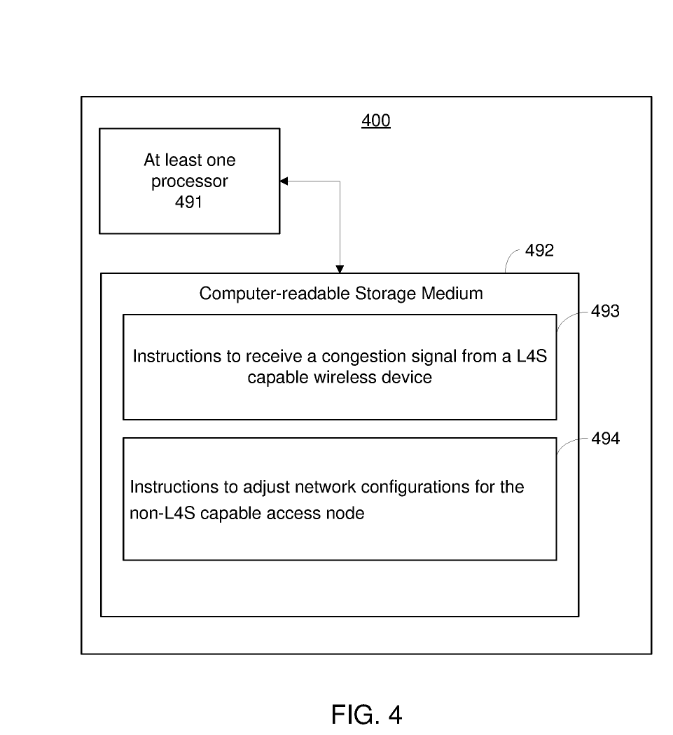

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to a computing device. The instruction stored on computer-readable storage medium may be used to implement method steps described in reference to FIG. 3.

In this example, computer-readable storage medium 492 is encoded with a set of instructions 493 and 494. In embodiments, executable instructions included in each block may be included in different blocks shown and blocks not shown.

Instruction 493, when executed by at least one processor 491, configures the at least one processor 491 to receive congestion signal(s) s.

Instruction 494, when executed by at least one processor 491, configures the at least one processor 491 to adjust network configuration for the non-L4S capable access node.

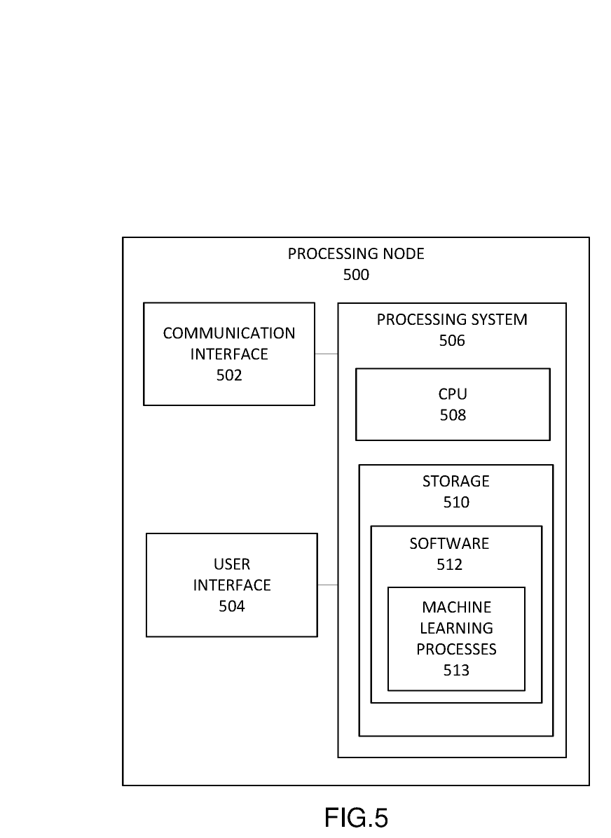

In embodiments, computer-readable storage medium 392 may include instructions configuring the at least one processor 391 to determine the session configuration used for adjusting the network configurations for the non-L4S capable access node as a function of a machine leaning model. The machine learning model is described in further detail in reference to FIG. 5.

Now referring to FIG. 5, an example processing node 500, which may be configured to perform the methods and operations disclosed herein for network congestion management. The processing node 500 includes a communication interface 502, user interface 504, and processing system 506 in communication with communication interface 502 and user interface 504. Communication interface 502 may include hardware components, such as network communication ports, devices, routers, wires, antenna, transceivers, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 512 may include the instructions described in reference to FIG. 4.

In embodiments, software 512 includes machine learning processes 513. In embodiments, processing system 506 may use machine learning processes 513 to perform determinations, classifications and or analysis steps. In embodiments, machine learning processes 513 may be used to generate a machine learning model. For example, processing node 500 may be configured used for adjusting network configurations for the non-L4S capable access nodes, such as non-L4S capable access node 172 described in reference to FIG. 1, using machine learning processes 513.

In instances, processing system 506 may use machine learning processes 513 to generate training data. In embodiments, processing system 506 may use the training data to train a machine learning model. For example, machine learning processes 513 may model relationships between two or more categories of data elements using the training data. In embodiments, training data may include historical congestion data from L4S capable access nodes and wireless devices. In some examples, training data may include one or more elements not categorized. In embodiments, machine learning processes 513 may include a neural network. As used herein, a neural network is a network of data structures, or nodes, that contains one or more inputs, one or more outputs and a function for determining outputs based on the inputs, where the network includes an input layer, an output layer and oner or more intermediate layers. In instances, neural network may have a recurrent architecture, such as a recurrent neural network (RNN). For example, RNN may be used for generating time series predictions. In embodiments, the neural network may have a memory cell based architecture, such as a long short-term memory (LSTM) network. For example, LSTM may be used for generating time series forecasting based on long term dependencies.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless network communicatively connected to a Low Latency Low Loss Scalable Throughput (L4S) capable access node and a non-L4S capable access node, a congestion signal from an L4S capable wireless device; and
in response to receiving the congestion signal from the L4S capable wireless device, adjusting, by the wireless network, network configurations for a non-L4S capable access node.

2. The method of claim 1, wherein adjusting the network configurations for the non-L4S capable access node comprises prioritizing low-bitrate slices.

3. The method of claim 1, wherein adjusting the network configurations for the non-L4S capable access node comprises adjusting power control settings in uplink (UL).

4. The method of claim 1, wherein adjusting the network configurations for the non-L4S capable access node comprises adapting slice configurations for the non-L4S capable access node.

5. The method of claim 1, wherein adjusting the network configurations for the non-L4S capable access node comprises prioritizing essential non-L4S traffic.

6. The method of claim 1, wherein adjusting the network configurations for the non-L4S capable access node comprises reducing UL layers for the non-L4S capable access node.

7. The method of claim 1, wherein adjusting network configurations comprises assigning the non-L4S capable wireless device to the non-L4S capable access node.

8. The method of claim 1, wherein adjusting network configurations comprises moving the non-L4S capable wireless device from the L4S capable access node to the non-L4S capable access node.

9. The method of claim 1, adjusting uplink (UL) and download (DL) resource allocation to optimize for stability.

10. The method of claim 1, wherein adjusting network configurations comprises adjusting cell boundaries.

11. A wireless network, the wireless network comprising:
a Low Latency Low Loss Scalable Throughput (L4S) capable access node;
a non-L4S capable access node; and
at least one computing device configured to:
receive, a congestion signal from a L4S capable wireless device; and
in response to receiving the congestion signal from the L4S capable wireless device, adjust network configurations for the non-L4S capable access node.

12. The wireless network of claim 11, wherein a machine learning model determines network configurations used for adjusting the network configurations for the non-L4S capable access node.

13. The wireless network of claim 12, wherein the machine learning model is trained using training data comprising historical L4S congestion data.

14. The wireless network of claim 13, wherein the historical L4S congestion data comprises one or more of latency, ECN marking levels, and packet loss from L4S supporting access nodes.

15. The wireless network of claim 14, wherein the machine learning model is trained using training data comprising historical congestion data.

16. A non-transitory computer-readable medium storing instructions, when executed by at least one processor, configures a wireless network to perform actions comprising:
receiving, by the wireless network that is communicatively connected to a Low Latency Low Loss Scalable Throughput (L4S) capable access node and a non-L4S capable access node, a congestion signal from an L4S capable wireless device; and
in response to receiving the congestion signal from the L4S capable wireless device, adjusting, by the wireless network, network configurations for a non-L4S capable access node.

17. The non-transitory computer-readable medium of claim 16, wherein adjusting the network configurations for the non-L4S capable access node comprises prioritizing low-bitrate slices.

18. The non-transitory computer-readable medium of claim 16, wherein adjusting the network configurations for the non-L4S capable access node comprises adjusting power control settings in uplink (UL).

19. The non-transitory computer-readable medium of claim 16, wherein adjusting the network configurations for the non-L4S capable access node comprises adapting slice configurations for the non-L4S capable access node.

20. The non-transitory computer-readable medium of claim 16, wherein adjusting the network configurations for the non-L4S capable access node comprises prioritizing essential non-L4S traffic.
